(19) United States
(12) Patent Application Publication
(10) Pub. No.: US 2005/0092450 A1
(43) Pub. Date: May 5, 2005

(54) PVP creping adhesives and creping methods using same

(76) Inventor: Walter Bernard Hill JR., Germantown, TN (US)

Correspondence Address: KILYK & BOWERSOX, P.L.L.C., 53 A EAST LEE STREET, WARRENTON, VA, 20186, US

(21) Appl. No.: 10/697,551

(22) Filed: Oct. 30, 2003

(51) Int. Cl. B31F 1/12

(52) U.S. Cl. 162/112; 162/168.1; 162/158; 162/164.6; 162/113

(57) ABSTRACT

A method for manufacturing a creped fiber web is described in which an adhesive contains at least one type of polyvinylpyrrolidone and contains substantially no ethoxylated acetylenic diol, and substantially no oxazoline polymer. The adhesive is used to adhere a fiber web to a dryer surface for drying the fiber web, and then creping the dried fiber web from the dryer surface. Also described are creping adhesives that do not contain chloride or epichlorohydrin.

### BACKGROUND OF THE INVENTION

The present invention relates to the manufacture of creped paper including soft, absorbent tissue/towel paper webs and also relates to the mode of creping of such webs to attain adequate softness and adhesive characteristics in the web while minimizing operational difficulties.

A thin paper web can be formed from a slurry of water and fiber, dewatering the wet web, and then at least partially drying the dewatered web. The web is then conveyed or carried on a fabric to a large steam-heated rotary drum, termed in the art, a Yankee dryer. The web commonly enters the dryer at a circumferential dryer position which is a major portion around the dryer from the zone of web de-contact from the drum. The de-contact zone is equipped with a creping blade against which the web abuts so as to be pushed backwardly upon itself and attain the well-known tissue creped paper structure.

The creping action requires that the web be well-adhered to the dryer to effect a consistent and uniform creping action, and, for example, to prevent flaring of the web from the dryer before or at the exit zone in the vicinity of the creping blade. In some instances the web is presented to the dryer at a considerable moisture content that is typically as high as about 60%. Such webs accordingly have fiber consistencies at the point of contact with the dryer of about 40%. The moisture content, depending upon the condition of the web surface and the Yankee dryer surface, may tend to cause the web to adhere to the dryer throughout the drying action of the rotating drum without the application of an adhesive to the dryer surface.

In more common modes of operation commonly referred to as “through-air drying,” however, contact of the web with the dryer surface is limited. In a through-air drying operation, the web formed from the slurry of water and fiber is dewatered without significantly pressing the wet web. This is followed by a drying action in a hot air blast. The resulting webs are then pressed to the Yankee dryer using a knuckled fabric so that the web adheres to the dryer in closely spaced contact zones, with bulking of the web between the contact zones. Fabrics having as fine a count as 4,900 openings per square inch and above may serve the purpose. The fiber consistency of such webs when presented to the dryer may be from about 30% to about 90% fiber. Higher fiber-consistency webs typically require an adhesive to adequately secure the web to the dryer for completion of both the drying action and creping action.

A variety of adhesives have been employed for retaining a web on a dryer surface. Conventional adhesives include polyvinyl acetate-ethylene copolymer emulsions and aqueous polyvinyl alcohol solutions. It has been found that polyvinyl acetate-ethylene copolymer compositions that may contain small percentages of polyvinyl alcohol such as less than about 5% of the total solids by weight, are generally adequate for the purpose, but their use is accompanied by a number of undesirable effects. Polyvinyl alcohol compositions pose similar problems when used as creping adhesives.

Currently, most creping adhesives are based on wet strength resins, namely, polyamidoamines cross-linked with epichlorohydrin (PAE). However, PAE-based creping adhesives have numerous drawbacks. For example, PAE-based adhesives are not “rewettable” (i.e., capable of being activated on the dryer surface when contacted by the web from the moisture content in the web). To prevent the undesirable effects of the buildup of adhesive on the dryer surface mentioned above, a creping adhesive is preferably rewettable. Rewettability also affects adhesiveness, particularly as the moisture content in the web decreases, i.e., higher fiber-consistency webs. In addition, PAE adhesives contain chloride, and thus are corrosive. Also, toxicity is an issue with the use of PAE as a creping adhesive given the presence of epichlorohydrin (EPI) and/or its derivatives. Further, PAEs cross-link, and thus exhibit monolithic properties. Yet another drawback to PAE adhesives is poor fracturing properties.

Accordingly, a need exists for a creping adhesive that has one or more of the following properties: rewettability, noncorrosiveness, low toxicity, a range of physical properties, and good fracturing properties, as well as superior adhesiveness for both low and high moisture content webs.

### SUMMARY OF THE PRESENT INVENTION

It is therefore a feature of the present invention to provide a rewettable creping adhesive.

Another feature of the present invention is to provide a creping adhesive that contains substantially no epichlorohydrin (and/or its derivatives), and/or substantially no chloride.

A further feature of the present invention is to provide a creping adhesive that does not cross-link upon heating, and that exhibits a wide range of physical properties.

Yet another feature of the present invention is to provide a creping adhesive having superior fracturing properties.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a process for manufacturing a creped fiber web. The process generally includes applying to a web dryer surface an adhesive that contains at least one polyvinylpyrrolidone (PVP), and less than 0.05 wt. % ethoxylated acetylenic diol, and less than 1 wt. % oxazoline polymer; conveying a fiber web to the web dryer surface; drying the fiber web on the web dryer surface to form a dried fiber web; and creping the dried fiber web from the web dryer surface. The PVP adhesive optionally contains PAE, polyvinyl alcohol, polyamines, polyquats, or other suitable additives.

The present invention further relates to a process for manufacturing a creped fiber web in which the adhesive dryer surface has superior adhesion to the fiber web for webs having low or high moisture content.

It is to be understood that both the foregoing general description and the following detailed description are exemplary and explanatory only and are intended to provide a further explanation of the present invention, as claimed.

### BRIEF DESCRIPTION OF DRAWINGS

FIG. 1 is a flow chart illustrating a process according to the present invention.

FIG. 2 is a schematic illustration of a creping system that can be used in combination with a PVP adhesive according to the present invention.

### DETAILED DESCRIPTION OF THE PRESENT INVENTION

A method of manufacturing creped paper, including soft, absorbent tissue/towel paper, according to the present invention includes using an adhesive containing at least one type of polyvinylpyrrolidone (PVP) to adhere a fiber web to a web dryer surface, and then creping the fiber web from the web dryer surface. According to one embodiment of the present invention, a process for manufacturing a creped fiber web includes applying an adhesive to a web dryer surface; conveying a fiber web to the web dryer surface; drying the fiber web on the web dryer surface to form a dried fiber web; and creping the dried fiber web from the web dryer surface, wherein the adhesive contains at least one type of polyvinylpyrrolidone, and wherein the adhesive preferably contains less than 0.05 wt. % ethoxylated acetylenic diol, and less than 1 wt. % oxazoline polymer. More preferably, the adhesive contains 0 wt. % ethoxylated acetylenic diol and 0 wt. % oxazoline polymer.

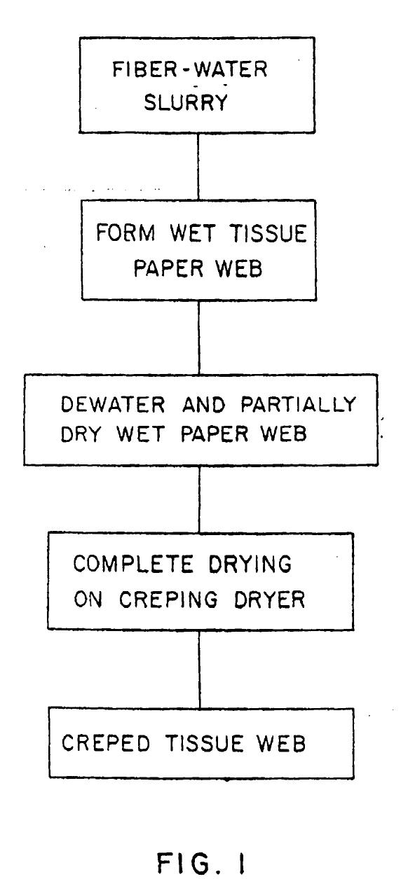

According to the present invention, a thin paper web or fiber web can be formed from a slurry of water and fiber using a conventional web forming technique. The fiber web can then be dewatered, and preferably is at least partially dried. According to one embodiment of the present invention, the fiber web is preferably dried to a fiber consistency of from about 10 to about 90%, and more preferably from about 40 to about 50% by weight before being conveyed to the web dryer surface. The web can then be conveyed, e.g., carried on a fabric, to a creping dryer or web dryer, which is preferably a large, steam-heated rotary drum dryer, referred to herein and elsewhere as a Yankee dryer. The fiber web can enter the web dryer at a circumferential dryer position that is preferably at least about halfway around, and more preferably at least about 75% around the cylindrical dryer with respect to the zone of dried fiber web de-contact from the web dryer surface or dryer drum. The de-contact zone can be equipped with a creping blade against which the web abuts so as to be pushed backwardly upon itself and attain the well-known tissue crepe paper structure. A flow chart illustrating a process according to the present invention is shown in FIG. 1.

The creping action can be facilitated by ensuring that the web is well-adhered to the web dryer surface to effect a consistent and uniform creping action, and for example, to prevent flaring of the fiber web from the web dryer surface before or at the exit zone in the vicinity of the creping blade. The fiber web can be presented to the web dryer at a considerable moisture content of up to about 90% by weight based on the weight of the web. Webs having moisture contents of from about 10% or less by weight to about 90% or more by weight, such as from about 40% by weight to about 60% by weight, can be processed according to the methods of the present invention. Such webs accordingly would have fiber contents making up the additional wt. % of the web. The moisture content, depending upon the condition of the fiber web surface and the Yankee dryer surface, may tend to cause the fiber web to adhere strongly to the web dryer throughout the drying action of the rotating dryer drum. Under such circumstances, a supplemental adhesive is not needed, and in some cases the adhesion to the dryer may be so strong that a release agent such as silicone oil, other oils, surfactants, soaps, shampoos, or conventional additives for creping adhesives or other adhesives, can either be applied between the web dryer and the fiber web, or, for example, mixed with the adhesive, to limit the extent of adhesion.

In some modes of operation commonly referred to herein as through-air drying, contact of the fiber web with the web dryer surface can be limited. In a through-air drying operation according to the present invention, the fiber web formed from the slurry of water and fiber is dewatered without significantly pressing the wet fiber web. Dewatering can be followed by a drying action that includes a hot air blast. The resulting fiber webs can then be pressed to the Yankee dryer using a knuckled fabric so that the knuckled fiber web adheres to the web dryer in closely spaced contact zones, with bulking of the fiber web between the contact zones. Fabrics having as fine a count as 4,900 openings per square inch and above may serve the purpose. The fiber consistency of such fiber webs when presented to the web dryer can be from about 10% by weight to about 90% by weight fiber. According to one embodiment of the present invention, the fiber web is conveyed or carried on a fabric to the web dryer surface, and transferred from the fabric to the web dryer surface. The fabric can be a transfer and impression fabric having knuckles which compact a portion, e.g., about 20%, of the surface of the fiber web to form a knuckled fiber web, and preferably the adhesive retains the knuckled fiber web on the web dryer surface until a fiber consistency of the knuckled fiber web is about 75% or more, for example, at least about 95%.

The adhesives used according to the present invention can be used with through-air drying systems and creping methods, with Yankee dryer systems and methods, and with wet-crepe machines, systems, and methods, as well as other creping methods and systems. Other teachings of creping systems, methods, and adhesives are described in the following U.S. Patents which are incorporated herein in their entireties by reference: U.S. Pat. Nos. 3,640,841; 4,304,625; 4,440,898; 4,788,243; 4,994,146; 5,025,046; 5,187,219; 5,326,434; 5,246,544; 5,370,773; 5,487,813; 5,490,903; 5,633,309; 5,660,687; 5,846,380; 4,300,981; 4,063,995; 4,501,640; 4,528,316; 4,886,579; 5,179,150; 5,234,547; 5,374,334; 5,382,323; 5,468,796; 5,902,862; 5,942,085; 5,944,954; 3,879,257; 4,684,439; 3,926,716; 4,883,564; and 5,437,766.

According to the present invention, the adhesive includes at least one type of PVP, e.g., (C₆H₉NO)_{N}. An exemplary commercially available PVP is identified by CAS number 9003-39-8. One supplier is ISP. A preferred PVP is represented by the formula:

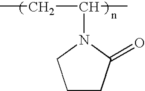

Exemplary commercially available PVPs and their properties which can be used to practice the present invention are set forth in Table 1 below. The different PVPs can be used alone or in combination. The PVP can be in any physical form, and is preferably in an aqueous solution in a concentration of from about 1 to about 90% by weight of the overall aqueous solution. Other amounts can be from about 10 to about 50% by weight, and from about 10 to about 30% by weight. The PVP can have an average molecular weight of from about 6,000 Daltons or less to about 3,000,000 Daltons or more and preferably from about 50,000 to about 1,500,000 Daltons. Other molecular weights can be used. Preferably, the molecular weight is such that PVP is a solid at ambient temperatures (e.g., about 25° C.). The PVP can have a K value (viscosity of 1% solution) of from about 10 to about 150, and preferably, from about 25 to about 100. The K value is a measurement of polymer molecular weight by a viscosity determination as is known in the art. Other K values can be used. The PVP can have a glass transition temperature (T_{g}) of from about 110 to about 190° C., and preferably, from about 160 to about 175° C. PVPs having other T_{g} can be used.

The adhesive can contain from about 0.05% to about 100% PVP by weight of the adhesive. The creping adhesive of the present invention can be a formulation of one or more known adhesive compounds or other components. For example, the adhesive can further contain PAE, polyvinyl alcohol, polyamines, polyquats, or any combination thereof. The polyvinyl alcohol can be present, for instance, in an amount of up to about 99% by weight based on the weight of the adhesive.

The adhesive of the present invention preferably contains from about 0 to less than 0.05 wt. % ethoxylated acetylenic diol. For example, the adhesive can contain less than about 0.25 wt. % or 0 wt % ethoxylated acetylenic diol. Other examples include less than about 0.01 wt. %, less than about 0.005 wt. %, and less than about 0.0001 wt. % ethoxylated acetylenic diol.

The adhesive of the present invention preferably contains from about 0 to less than 1 wt. % or 0 wt % oxazoline polymer. For example, the adhesive can contain less than about 0.5 wt. %. Other examples include less than about 0.1 wt. %, less than about 0.05 wt. %, and less than about 0.01 wt. % oxazoline polymer.

The adhesive of the present invention preferably contains substantially little or no EPI, including EPI derivatives. For example, the adhesive can contain less than about 10% by weight EPI and/or EPI derivatives, and preferably contains less than about 1%, and more preferably less than about 0.1%, and most preferably 0% by weight EPI and/or EPI derivatives. The adhesive of the present invention preferably contains substantially no or no halogens, such as chlorine. For example, the halogen content of the adhesive can contain less than about 10% by weight halogens, and preferably contains less than about 1 wt. %, and more preferably less than about 0.1 wt. %, and most preferably 0 wt. % halogens.

TABLE 1

| | | | | | PVP K- | | | | |
|---|---|---|---|---|---|---|---|---|---|
| Property | PVP K-15 | | PVP K-30 | | 60 | PVP K-90 | | PVP K-120 | |
| Appearance | Pale | Off-white, | Colorless | Off-white, | Yellow | Yellow, | Off- | Colorless | Off-white, |
| @ 25° C. | yellow | formless | to pale | formless | aqueous | Viscous, | white, | to yellow | formless |
| | aqueous | powder | yellow | powder | solution | aqueous | formless | aqueous | powder |
| | solution | | aqueous | | | solution | powder | solution | |
| | | | solution | | | | | | |
| K-Value | 13-19 | 13-19 | 27-33 | 26-35 | 50-62 | 80-100 | 90-100 | 110-130 | 108-130 |
| (Viscosity of | | | | | | | | | |
| 1% solution) | | | | | | | | | |
| Color | 4 max. | 100 max. | 150 max. | 80 max. | 100 | 40 max. | 60 max. | 25 max. | 50 max. |
| (APHA) | (VCS) | | | | max. | | | | |
| % Residual | 0.1 max. | 0.1 max. | 0.001 | <0.1 | <0.1 | <0.1 | <0.1 | <0.1 | 0.1 max. |
| VP | | | max. | | | | | | |
| % Active | 28-32 | 95 min. | 29-31 | 95 min. | 45-49 | 20-24 | 95 min. | 11-13 | 95 min. |
| % Moisture | 68-72 | 5 max. | 69-71 | 5 max. | 51-55 | 76-80 | 5 max. | 87-89 | 5 max. |
| % Ash | 0.012 | 5 max. | 0.012 | 0.02 max. | 0.044 | 0.016 | — | 0.018 | — |
| (combustion) | | | | | | | | | |
| pH (5% | 6-9 | 3-7 | 6-9 | 3-7 | 3-7 | 3-7 | 3-7 | 6-9 | 4-8 |
| aqueous | | | | | | | | | |
| solution) | | | | | | | | | |
| M w Range | 6,000-15,000 | | 40,000-80,000 | | 240,000-450,000 | 900,000-1,500,000 | | 2,000,000-3,000,000 | |
| Brookfield | 1 | | 3 | | 10 | 150 | | 350 | |
| Viscosity | | | | | | | | | |
| (cps) | | | | | | | | | |
| Brookfield | 10-15 | — | 200-500 | — | 1,800,000 | 29,000-62,000 | — | 48,000-75,000 | — |
| Viscosity, | | | | | | | | | |
| cps - as is @ | | | | | | | | | |
| 25° C. | | | | | | | | | |
| Specific | 1.061 | — | 1.062 | — | 1.122 | 1.051 | — | 1.024 | — |
| Gravity @ | | | | | | | | | |
| 25° C. | | | | | | | | | |
| Bulk Density | — | 0.6-0.7 | — | 0.4-0.6 | — | — | 0.3-0.4 | — | 0.2-0.3 |
| (g/cc) | | | | | | | | | |
| Film Density | 1.203 | — | 1.207 | — | — | 1.216 | — | — | — |
| (g/cc) | | | | | | | | | |
| Freezing | −4.1 | — | −2.7 | — | −2.2 | −0.9 | — | 0.3 | — |
| Point (° C.) | | | | | | | | | |
| Tg (° C.) | — | 130 | — | 163 | 170 | — | 174 | — | 176 |

The adhesive can be applied to the web dryer surface, and/or optionally the fiber web itself, by any method, including, but not limited to, spraying, roll coating, knife coating, or any combination thereof. The adhesive is preferably sprayed onto the web dryer surface. The adhesive is preferably applied to the web dryer surface at a rate, relative to the rate of dryer surface rotation, that provides an adequate amount of adhesive to hold the fiber web during drying, and yet release the dried fiber web upon completion of drying. Conventional adhesive coverage rates and weights can be used as are known to those skilled in the art. Exemplary application rates of the adhesive on the web dryer surface can range from about 10 mg/m² or less to about 500 mg/m² or more, for example, from about 50 mg/m² to about 200 mg/m², or from about 85 mg/m² to about 100 mg/m², based on the solids weight of the adhesive composition. Preferably, the adhesive is continuously applied to the rotating dryer so that an adequate amount of adhesive is always on the web dryer surface.

Referring now to the drawings, FIG. 1 is a flow chart showing a series of steps that can be used according to the present invention for the formation of a tissue paper web suitable for use as facial tissue, toilet tissue, sanitary napkin wrappers, and the like. Such webs can have a finished basis weight usually in the range of from about 7 or less to about 40 or more pounds per 3,000 ft², and are formed from aqueous fiber slurries. In specific applications, such a slurry may have a fiber content by weight of about 0.3% or more. The slurry is directed to a conventional Fourdrinier drainage wire to form a fiber web. Dewatering of the fiber web occurs through the wire in a conventional manner and the drained web, having a fiber consistency of preferably from about 20 to about 60% is directed to through-drying equipment. The web exits the through-dryer at a fiber content or consistency of about 80% by weight (other fiber contents can be used) and is passed to a transfer and impression fabric which carries the web to the creping dryer. Such a transfer fabric can, for example, be characterized by about 78 meshes per inch in the machine direction, 72 meshes per inch in the cross-direction, and impression fabric knuckles can be provided to compact about 20% of the surface of the web on a creping or Yankee dryer. The web is creped from the dryer to form a dried web having a fiber content or consistency of about 95%, and preferably is then wound into rolls. Again, other fiber contents can be used.

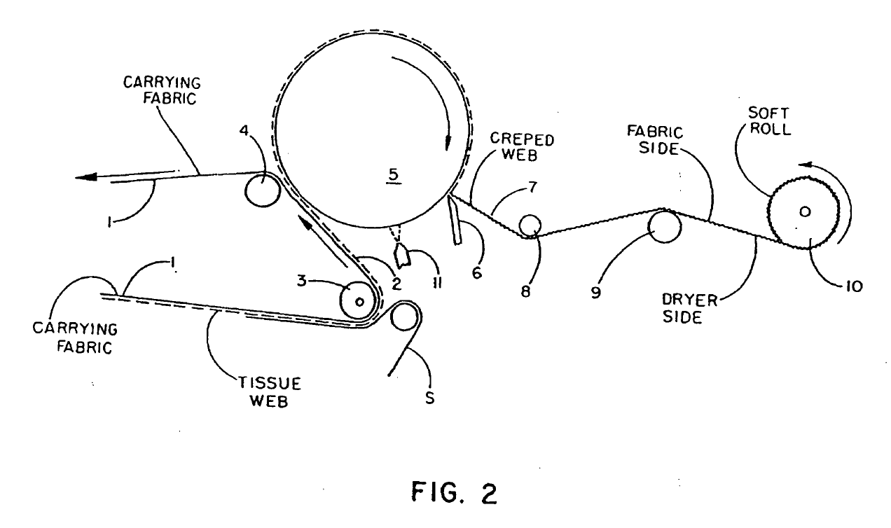

Referring to FIG. 2, the transfer and impression fabric designated reference numeral 1 carries the formed, dewatered, and partially dried web 2 around turning roll 3 to the nip between press roll 4 and the Yankee dryer 5. A supplemental lower carrier designated at S may also be employed to carry the web in sandwich fashion, which may be particularly useful under conditions of higher web dryness. The fabric, web, and dryer move in the directions indicated by the arrows. The entry of the web into the dryer is well around the roll from creping blade 6, which, as is schematically indicated, crepes the traveling web from the web dryer as indicated at 7. The creped web 7 exiting from the dryer passes over guide and tension rollers 8, 9 and is wound into a soft creped tissue roll 10.

To adhere the relatively dry fiber web 2 (at, for example, 80% fiber consistency) entering the dryer to the surface of the dryer, a spray 11 of adhesive is applied to the web dryer surface ahead of the nip between the press roll 4 and creping dryer surface 5. The adhesive spray can be applied to the traveling web 2 directly, but is preferably sprayed directly onto the web dryer surface, so as to limit the absorption of adhesive by the fiber web and to limit the penetration of adhesive through the fiber web to the carrying fabric.

The adhesive spray is preferably aqueous and suitably has a solids content of from about 0.5% by weight to as much as about 70% by weight or more, preferably from about 1% to about 20% solids. For spraying, a range of solids contents of from about 0.75% to about 15% by weight is more preferred although any suitable solids content can be used. For roll coating of the adhesive onto the dryer surface, or knife coating, higher solids contents may be employed, such as from about 1% by weight to about 70% by weight, for example, from about 3% by weight to about 50% by weight.

The previously described versions of the present invention have many advantages, including more adhesion at higher moistures and at lower temperatures when compared to conventional creping adhesives, especially those used on through-air dryers. The adhesives also fracture at the blade in a unique way, making an excellent crepe structure, even at high sheet moisture contents. Because polyvinylpyrrolidone does not crosslink, the PVP adhesives are also rewettable. The complete rewettability of the PVP adhesives minimizes irreversible felt filling, deposit formation, and clean-up time and efforts, in contrast to conventional resin adhesives that are not. The rewettability of the PVP adhesive results in reactivation of the PVP adhesive that is present on the web dryer surface upon contact with the moisture laden web. Thus, the PVP adhesive does not coat the web dryer surface with a hard and uneven film that builds up in the drying/creping process which would produce uneven creping. Removal of such a hard film of adhesive would require use of a cleaning blade against the web dryer surface, thereby causing undesirable wear of the web dryer surface. Rewettability also improves adhesiveness, particularly in low moisture content webs.

Experiments demonstrate the superiority of PVP adhesive over conventional standard through-air dryer creping adhesives, particularly over current adhesives that include a combination of polyvinyl alcohol, sorbitol (or sucrose), and release agents (surfactants or oil-based surfactant formulations) used for creping on a through-air dryer system.

The adhesives used according to the present invention provide superior creping, and fracture nicely at the creping blade, exploding the sheet and increasing creping quality. The adhesives also provide superior adhesion at high moisture contents, and are more adhesive at low and high web or sheet moisture contents.

The adhesives used according to the present invention also provide enhanced runnability. Creping with the PVP adhesives enhance operational runnability because PVP retains its adhesion over wide moisture and temperature ranges. Moisture variability, which can be common across a sheet surface, does not change the creping effectiveness when PVP adhesives are used according to the present invention, thus resulting in a more uniform and higher quality tissue/towel product.

The adhesives used according to the present invention are not corrosive because they do not contain chloride. PVP has low toxicity, with a designated permissible exposure limit (PEL) of 8 hours over 2.5%, in part because they do not contain epichlorohydrin. PVP has a wide range of molecular weights and a corresponding wide range of physical properties (e.g., glass transition temperatures), which are maintained even at high temperatures.

Creped products produced using the present methods and adhesives of the present invention, and using through-air dryers, results in superior creped tissue and towel products when compared to products made by systems and methods that use conventional adhesives.

In addition, the adhesives used according to the present invention can be used on enhanced through-air dryer systems, on Yankee dryer systems, and with wet creping systems. The PVP adhesives enhance the creping performance in any type of tissue and towelling process, including through-air dryer processes, Yankee dryer processes, and wet crepe tissue machine processes. Furthermore, creping can be done at high sheet moisture contents, where prior systems using hard resins (like wet strength resins) and soft resins have failed. The present PVP adhesives fill this gap either alone or in combination with existing creping adhesive products, providing excellent adhesion at higher moisture contents.

The present invention will be further clarified by the following examples, which are intended to be exemplary of the present invention.

### EXAMPLES

A hot plate comparison was made of various adhesive formulations with the temperature of the hot plate at 116° C., the results of which are set forth in Table 2.

TABLE 2

| | | | | | Moderate- | | | | |
|---|---|---|---|---|---|---|---|---|---|
| | | | | | ly | Slightly | | | |
| | | | | | Cross- | Cross- | | | Highly |
| | | | | | linked | linked | | Polyvinyl | Crosslinked |
| Property | PAE | PVP 90 | PVP 15 | Polyquat | Polyamine | Polyamine | Polyamine | Alcohol | Polyamine |
| Appearance | Shinny, | Dull, even | Brittle, | Dull, | Glassy, | — | Glassy, | White, | Dull, smooth |
| | glassy | | bumpy, | smooth | smooth, | | smooth, less | crystaline, | |
| | | | bubbly | | gummy | | gummy than | bumpy, very | |
| | | | | | | | slightly | hard gum | |
| | | | | | | | crosslinked | | |
| | | | | | | | polyamine | | |
| Color | Darkened | No change | No change | No change | No change | No change | No change | White, did not | No changes |
| | | | | | | | | darken | |
| Shatter - Cold | Low | Moderate | High | Moderate | None | None | None | Low, gummy | Moderate |
| Shatter - Hot | Low - | Moderate | High | Moderate | None | None | None | Low, gummy, | Moderate |
| | comes out | | | | | | | harder than | |
| | in sheets | | | | | | | highly | |
| | | | | | | | | crosslinked | |
| | | | | | | | | Polyamine | |
| Adhesion - | Low | Moderate - | Moderate | High | Moderate | — | Moderate | Low - not | Moderate |
| Cold | | slippery | | | | | | tacky | |
| Adhesion - | Low-hard, | Moderate | Moderate | Moderate | Moderate- | — | Moderate- | Moderate | Moderate |
| Hot | but not | | | | gummy | | gummy | | |
| | gummy | | | | | | | | |
| Rewettability | Very low | High | High | Moderately | High | High | High | Moderate | Moderately |
| | | | | high | | | | | high |

Table 3, shows the formulated creping adhesives using two PVP products blended in the proportions given with various adhesive products available from Buckman Laboratories International, Inc. and other vendors. Some of the formulations also included other compounds such as, water and H₂SO₄. Generally, the results of a comparison of the formulations showed that PVP-containing formulations enhance creping adhesion at high temperatures, and are 100% rewettable. Invariably, formulations prepared with PVP showed that PVP enhanced the film and adhesion performance of conventional adhesives in comparison to the adhesives' original formulations.

TABLE 3

| | BBD 2071* | | BBD 2073* | | BBD 2062* | | BBD 2068* | | BBD 2078* | | | | BBD 2071* | PVP15 |
|---|---|---|---|---|---|---|---|---|---|---|---|---|---|---|
| | w/PVP | | w/PVP | | w/PVP | | w/PVP | | w/PVP | | BBD 2071* | BBD 2071* | w/polyvinyl | w/BBD |
| | 15 | 90 | 15 | 90 | 15 | 90 | 15 | 90 | 15 | 90 | w /PAE | w/polyamine | alcohol | 2071* |
| | A | B | C | D | E | F | G | H | I | J | K | L | M | N |
| Polyamine | 72.5 | 72.5 | 66.0 | 66.0 | 31.9 | 31.9 | 30.3 | 30.3 | — | — | 60.0 | 60.0 | 60.0 | 10.0 |
| Highly | — | — | — | — | — | — | — | — | — | — | 11.3 | 11.3 | 11.3 | 1.89 |
| crosslinked | | | | | | | | | | | | | | |
| polyamine | | | | | | | | | | | | | | |
| PAE | — | — | — | — | — | — | — | — | — | — | 5.0 | — | — | — |
| Polyquat | — | — | — | — | — | — | 5.0 | 5.0 | — | — | — | 5.0 | — | — |
| PVP-15 | 21.8 | — | 33.0 | — | 9.04 | — | 9.52 | — | 68.2 | — | — | — | — | 55.0 |
| PVP-90 | — | 21.8 | — | 33.0 | — | 9.04 | — | 9.5 | — | 68.2 | — | — | — | — |
| Polyvinyl | — | — | — | — | — | — | — | — | — | — | — | — | 20.0 | — |
| alcohol | | | | | | | | | | | | | | |
| H₂SO₄ (%) | 2.0 | 2.0 | 1.0 | 1.0 | 2.6 | 2.6 | 2.4 | 2.4 | 0.0 | 1.0 | 6.0 | 3.0 | — | 1.0 |
| Water (%) | 3.7 | 1.6 | 0.00 | 0.00 | 56.5 | 56.5 | 52.7 | 52.7 | 31.8 | 30.8 | 17.7 | 20.7 | 8.7 | 32.1 |

*BBD 2071, 2073, 2062, 2068, and 2078 are commercially available from Buckman Laboratories International, Inc.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A process for manufacturing a creped fiber web, comprising:
applying an adhesive to a web dryer surface;
conveying a fiber web to said web dryer surface;
drying said fiber web on said web dryer surface to form a dried fiber web; and
creping said dried fiber web from said web dryer surface, wherein said adhesive comprises at least one polyvinylpyrrolidone, and wherein said adhesive comprises less than 0.05 wt. % ethoxylated acetylenic diol, and less than 1 wt. % oxazoline polymer.

2. The process of claim 1, wherein said polyvinylpyrrolidone has a K value of from about 10 to about 150.

3. The process of claim 1, wherein said polyvinylpyrrolidone has a Tg of from about 110 to about 190° C.

4. The process of claim 1, wherein said polyvinylpyrrolidone has an average molecular weight of from about 15,000 to about 120,000 Daltons.

5. The process of claim 1, wherein said adhesive comprises at least 95 wt. % polyvinylpyrrolidone

6. The process of claim 1, wherein said adhesive comprises from about 0.05 to about 100 wt. % polyvinylpyrrolidone.

7. The process of claim 1, wherein said adhesive further comprises PAE, polyvinyl alcohol, a polyamine, a polyquat, or combinations thereof.

8. The process of claim 1, wherein said adhesive contains substantially no chloride.

9. The process of claim 1, wherein said adhesive contains substantially no epichlorohydrin.

10. The process of claim 1, further comprising drying said fiber web to a fiber consistency of from about 10 to about 90% before said conveying of said fiber web to said web dryer surface.

11. The process of claim 1, wherein said fiber web is dried to a fiber consistency of from about 40 to about 50% by weight before said conveying of said fiber web to said web dryer surface.

12. The process of claim 1, wherein said drying comprises drying said fiber web to a fiber consistency of at least about 95% by weight prior to said creping.

13. The process of claim 1, wherein said conveying comprises carrying said fiber web on a fabric to said web dryer surface and transferring said fiber web from said fabric to said web dryer surface.

14. The process of claim 13, wherein said fabric is a transfer and impression fabric having knuckles which compact a portion of the surface of said fiber web to form a knuckled fiber web, and wherein said adhesive retains said knuckled fiber web on said web dryer surface until a fiber consistency of said knuckled fiber web is at least about 95%.

15. The process of claim 14, wherein said impression fabric knuckles compact about 20% of the surface area of said fiber web.

16. A creped fiber product made from the process of claim 1.

17. A process for manufacturing a creped fiber web, comprising:
adhering a fiber web to a web dryer surface using an adhesive; and
creping said fiber web from said web dryer surface, wherein said adhesive comprises at least one type of polyvinylpyrrolidone and less than 0.05 wt. % ethoxylated acetylenic diol, and less than 1 wt. % oxazoline polymer.

18. The process of claim 17, wherein said adhesive contains substantially no chloride.

19. The process of claim 17, wherein said adhesive contains substantially no epichlorohydrin.
